(19) United States
(12) Patent Application Publication
(10) Pub. No.: US 2003/0179238 A1
(43) Pub. Date: Sep. 25, 2003

(54) Method of and apparatus for highlighting region to be highlighted in display device, and record medium storing highlight method

(75) Inventor: Ui-chol Roh, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/390,018

(22) Filed: Mar. 18, 2003

(30) Foreign Application Priority Data
Mar. 23, 2002 (KR) 2002-15905

(51) Int. Cl. G09G 5/00

(52) U.S. Cl. 345/767

(57) ABSTRACT

A method of transmitting a control signal to highlight a highlighting region includes receiving a first window handle for a moving image reproducing program, comparing the first window handle with a second window handle for the moving image reproducing program to be highlighted, outputting coordinates of the second window handle when the first and second window handles are the same, and outputting control values for controlling red (R), green (G), blue (B) video signals, a contrast, or a sharpness of a region that is formed with the coordinates of the second window handle.

### CROSS-REFERENCE TO RELATED APPLICATIONS

This application claims the benefit of Korean Patent Application No. 2002-15905, filed Mar. 23, 2002, in the Korean Intellectual Property Office, the disclosure of which is incorporated herein by reference.

### BACKGROUND OF THE INVENTION

1. Field of the Invention

The present invention relates to a method of and an apparatus for highlighting a region to be highlighted (hereinafter, referred to as ‘highlighting region’), and more particularly, to a method of automatically detecting and highlighting a region in which a moving image is to be displayed, and sending a control signal for highlighting the highlighting region, and a recording medium recording this method.

2. Description of the Related Art

In general, a television displays moving images whereas a computer monitor displays text images. In other words, low-resolution images are displayed well on the television, and high-resolution images are displayed well on the computer monitor.

Extensive research has been performed on the development of various multimedia contents, such as texts, pictures, moving images, and games, to be displayed on the computer monitor. However, the existing computer monitors are designed to display text images whose contrast and sharpness are lower than newly developed moving images which are displayed on screens of televisions. Thus, the existing computer monitors are not appropriate for displaying the newly developed moving images. To display the moving images more clearly, the existing computer monitors need to increase the contrast and the sharpness of moving images. However, with the existing computer monitors, it is difficult to exactly control the sharpness and the contrast of a region in which the moving images are to be displayed at a desired level. In addition, a great increase in the contrast and the sharpness of a moving image on the computer monitor having a color display tube (CDT) results in a physical damage to the CDT. For these reasons, the existing computer monitors are not capable of appropriately controlling the sharpness and the contrast of the moving images and thus cannot effectively display these moving images.

### SUMMARY OF THE INVENTION

To solve the above and/or other problems, it is an aspect of the present invention to provide a method of automatically detecting and highlighting a region in which a moving image is to be displayed, and controlling details of the region, such as its contrast.

It is another aspect of the present invention to provide a method of sending a control signal to highlight a highlighting region and a recording medium therefor.

Additional aspects and advantages of the invention will be set forth in part in the description which follows and, in part, will be obvious from the description, or may be learned by practice of the invention.

To achieve the above and/or other aspects of the invention, a method of transmitting a control signal to highlight a highlighting region includes receiving a first window handle for a first (reference) moving image reproducing program, comparing the first window handle with a second window handle for a second moving image reproducing program that is to be highlighted, outputting coordinates of the second window handle when the first and second window handles are the same, and outputting control values for controlling red (R), green (G), blue (B) video signals, a contrast, or a sharpness of a region that is formed with coordinates of the second window handle.

When the first and second window handles are compared, a class name of the first window handle is compared with that of the second window handle.

The method may be recorded as a program that can be executed by a computer, and stored in a computer-readable recording medium.

According to another aspect of the invention, a method of highlighting a highlighting region, in which a moving image is to be reproduced, in a highlight mode includes receiving coordinates of a moving image corresponding to the highlighting region, and receiving control values for each controlling R, G, B video signal, a contrast or a sharpness of the highlighting region and controlling the R, G, B video signals, the contrast or the sharpness of the highlighting region.

According to another aspect of the invention, a method of controlling luminance of a highlighting region includes receiving moving image window coordinates corresponding to the highlighting region in which a moving image is to be reproduced, and receiving control values for increasing the luminance of the highlighting region and automatically increasing the luminance of the highlighting region to be brighter than the luminance of the other regions.

According to another aspect of the invention, a display device includes a control circuit receiving moving image coordinates for setting a highlighting region, in which a moving image is to be reproduced, in a highlight mode, and control values that are used to control R, G, B video signals, a contrast, or a sharpness of the highlight region, and a cathode display tube displaying an image corresponding to the R,G,B video signals adjusted in response to signals output from the control circuit.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a view of a computer system according to an embodiment of the present invention;

FIG. 2 is a view of a monitor screen where a region, in which a moving image is displayed, is displayed on a monitor of the computer system shown in FIG. 1; and

FIG. 3 is a flow chart explaining a method of automatically detecting and highlighting the region in which a moving image is to be displayed, and controlling details of the region, e.g., its contrast, on the monitor of the computer system shown in FIG. 1.

### DETAILED DESCRIPTION OF THE PREFERRED EMBODIMENTS

The present invention will now be described more fully with reference to the accompanying drawings, in which a preferred embodiment of the invention is shown. This invention may, however, be embodied in various forms and should not be construed as being limited to the embodiment set forth herein; rather, this embodiment is provided so that this disclosure will be thorough and complete and will fully convey the concept of the invention to those skilled in the art. The same reference numerals in different drawings represent the same element, and thus their descriptions will be omitted.

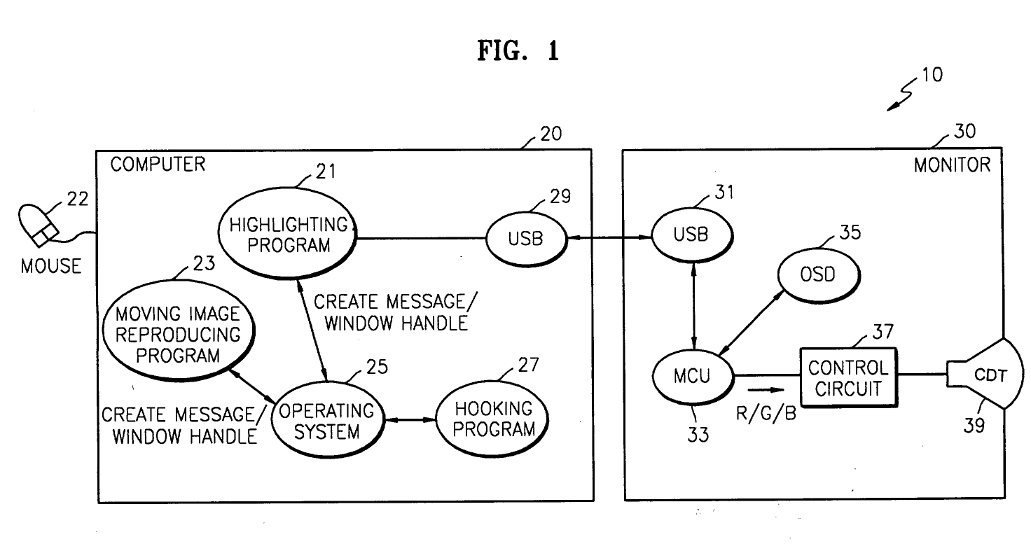

FIG. 1 is a view of a computer system 10 according to an embodiment of the present invention. The computer system 10 includes a computer 20 and a monitor 30. The computer 20 includes a highlighting program 21, a mouse 22, a moving image reproducing program 23, an operating system (OS) 25, a hooking program 27, and a first universal serial bus (USB) port 29.

The monitor 30 includes a second USB port 31, a main control unit (MCU) 33, an on-screen display (OSD) 35, a control circuit 37, and a color display tube (CDT) 39.

By operating the highlighting program 21, the computer system 10 detects a region, in which a predetermined moving image is reproduced by the moving image reproducing program 23, increases a brightness of the region, and outputs contrast, sharpness, and control values for adjusting red (R), green (G), and blue (B) video signals to the control circuit 37.

With the highlighting program 21, it is also possible to calculate coordinates of the region, in which the moving image is reproduced (hereinafter, referred to as “moving image window coordinates”), and output the calculated coordinates to the monitor 30 via the first and second USB ports 29 and 31 which are predetermined interfaces.

Here, the word of “highlighting” is to control or adjust a contrast, a sharpness, and R, G, B video signals with respect to the region, in which the moving image is reproduced, via the moving image reproducing program 23. The “highlighting region” is the region to be highlighted and set with the coordinates obtained by the MCU 33, which correspond to the moving image window coordinates.

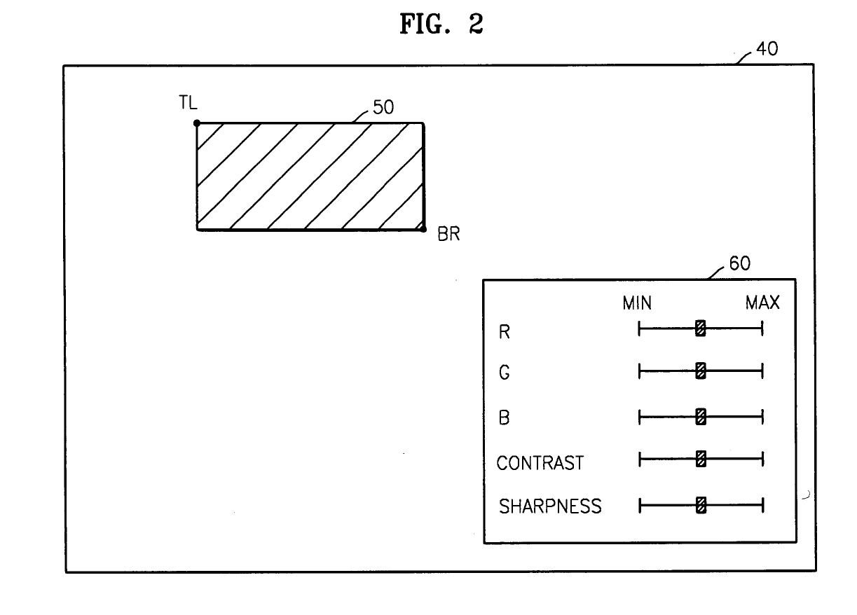

With the mouse 22, it is possible to control a size of the region in which the moving image is reproduced, i.e., increase or reduce the size of the region, and move a position of the region by dragging or clicking the region. Further, it is possible to adjust levels of the contrast, the sharpness, and the R, G, B video signals on a control window 60 shown in FIG. 2 using the mouse 22.

The moving image reproducing program 23 is a predetermined player program, such as WINDOW MEDIA PLAYER or REAL PLAYER, that reproduces the moving images on the monitor 30.

The OS 25 controls an overall operation of the computer system 10, manages the computer system 10, and further generates a create message for the highlighting program 21 and the moving image reproducing program 23 which are run in the computer system 10.

The hooking program 27 hooks a window handle with respect to the moving image reproducing program 23 and transmits the hooked window handle to the highlighting program 21.

The first USB port 29 outputs moving image window coordinates output from the highlighting program 21 and the control values for highlighting the highlighting region to the MCU 33 via the second USB port 31. In this embodiment, a USB port is adopted as an interface, but any interface unit, e.g., a serial port or a parallel port, may be used to exchange the moving image window coordinates and the control values between the computer 20 and the monitor 30.

The MCU 33 receives the moving image window coordinates and the control values via the second USB port 31, calculates the coordinates from the moving image window coordinates to set the highlighting region corresponding to a resolution of a screen of the monitor 30 or the CDT 39, and processes the control values for highlighting the set highlighting region.

In other words, the MCU 33 controls operations of the control circuit 37 in response to predetermined control signals, i.e., the control values, output from the second USB port 31.

Also, the MCU 33 controls the operations of the control circuit 37 in response to the moving image window coordinates output from the OSD 35 and the control values for highlighting the highlighting region.

The control circuit 37 controls image video signals, which include the R, G, B video signals, in the highlighting region in response to signals output from the OSD 35. That is, in response to the control values output from the MCU 33, the control circuit 37 adjusts the contrast, the sharpness, the R, G, B video signals and the luminance of the highlighting region in which the moving image is reproduced.

Accordingly, a user can call an adjusting dialog on a menu and highlight the highlighting region.

If the highlighting program 21 is run by the user, i.e., the highlighting program 21 is in a highlighting mode, to highlight the highlighting region, terminated and run again, the highlighting region is displayed in accordance with the control values that were set in a memory (not shown) before the termination of the highlighting program 21.

In other words, running the player program, such as the WINDOW MEDIA PLAYER by MICROSOFT CORP., that uses moving image reproducing modules, activates the highlighting program 21 to detect the region, in which the moving image is reproduced, and increase the luminance of the region.

Also, the user can adjust the contrast, the sharpness, the R, G, B video signals, or the luminance with respect to the region in which a moving image is reproduced, using the control window 60.

The highlighting program 21 or the OSD 35 controls the contrast, the sharpness, and the R, G, B video signals of the region in which the moving image is reproduced.

The OSD 35 controls the size and the position of the region, in which the moving image is reproduced, and adjusts the levels of the contrast, sharpness, and R,G,B video signals on the control window 60.

The CDT 39 receives signals output from the control circuit 37 and displays a highlighted moving image. Here, the CDT 39 may be replaced with a liquid crystal display (LCD) device or a plasma display panel (PDP) device.

The control circuit 37 receives the moving image window coordinates for setting the highlighting region to reproduce the moving image in the highlighting mode, and the control values for adjusting the contrast, the sharpness, and the R, G, B video signals with respect to the highlighting region.

The CDT 39 displays an image according to the R, G, B video signals, the contrast, and the sharpness that are adjusted in response to the signals output from the control circuit 37.

FIG. 2 is a view of a monitor screen 40 that displays a region 50, in which the moving image is displayed, and the control window 60.

The region 50 is set with the coordinates of the highlighting region that are converted by the MCU 33 of FIG. 1 to be displayed on the CDT 39. The position of the region 50 is determined by using top-left coordinates TL and bottom-right coordinates BR.

The control window 60 is displayed on the monitor screen 40 when the adjusting dialogue is called on the menu and displays images corresponding to the R, G, B video signals, the contrast, and the sharpness of the region 50.

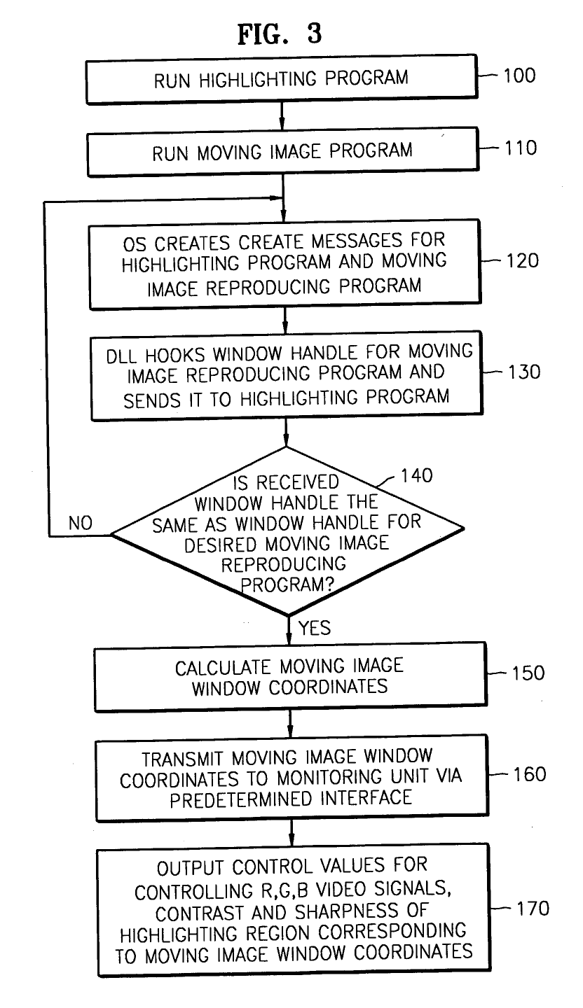

FIG. 3 is a flow chart explaining a method of automatically detecting and highlighting the region, in which the moving image is displayed, and controlling details of the region, such as its contrast.

Referring to FIGS. 1 through 3, the user runs the highlighting program 21 according to the present invention in operation 100 and then runs the moving image reproducing program 23 in operation 110. The user can run a plurality of moving image reproducing programs at once.

After operation 110, the OS 25 creates create messages for the highlighting program 21 and the moving image reproducing program 23 and informs the hooking program 27, such as Dynamic Link Library (DLL), of the creation of the create messages in operation 120.

The hooking program 27 hooks the window handle with respect to the moving image reproducing program 23 and transmits the hooked window handle to the highlighting program 21 in operation 130.

The highlighting program 21 checks whether the received window handle is the same as the window handle for the moving image reproducing program 23 to be highlighted in operation 140.

The highlighting program 21 according to the present invention detects a desired window handle for a class name among names which the window handles hold. For instance, the class name of the window handles for WIN 98, WINDOW ME, and for WINDOW 2000, which are all MICROSOFT WINDOWS operating systems, is VIDEORENDERER, and the class name of the window handle for WIN XP (WINDOW XP), which is also a MICROSOFT operating system, is WMPVIDEOWINDOW.

If it is determined in operation 140 that the received window handle is not the same as the window handle of the moving image reproducing program 23, it proceeds to operation 120. However, if the two window handles are the same, the highlighting program 21 calculates the coordinates for the moving image window of the region, in which the moving image is to be reproduced, in operation 150.

After operation 150, the highlighting program 21 outputs the moving image window coordinates to the monitor 30 via a predetermined interface in operation 160.

As previously mentioned, any interface, such as the serial port, the parallel port, or the USB port, can be adopted to exchange the moving image window coordinates and the control values between the computer 20 and the monitor 30.

In operation 170, the highlighting program 21 sends the MCU 33 the control values for adjusting the R, G, B video signals, the contrast, and the sharpness of the highlighting region. Thereafter, the MCU 33 receives the moving image window coordinates, converts them into the coordinates of the highlighting region, and outputs the control values to the control circuit 37.

In conclusion, the method of transmitting the control signal to highlight the highlighting region according to the present invention is implemented in the computer system 10 by the highlighting program 21.

The highlighting program 21 outputs the coordinates corresponding to the window handle for the moving image reproducing program 23 that is to be highlighted, to the monitor 30 if the received window handle is the same as the window handle for the moving image reproducing program 23.

Further, the highlighting program 21 outputs the control values for adjusting the R, G, B video signals, the contrast, and the sharpness of the highlighting region, which are produced by the coordinates of the highlighting region, to the monitor 30.

According to the present invention, the class name of the received window handle is compared with that of the moving image reproducing program 23 to be highlighted.

The method of highlighting the highlighting region 50, in which the moving image is reproduced, is performed on the monitor 30 in response to signals output from the highlighting program 21 in the highlight mode.

As described above, the method of highlighting the highlighting region according to the present invention allows the highlighting region, in which the moving image is to be displayed, to be automatically detected and highlighted.

Also, with the method of controlling the highlighting region, the user can appreciate an optimal moving image quality by controlling the R, G, B video signals, the contrast, and the sharpness of the highlighting region.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. A method of highlighting a screen of a display device, the method comprising:
receiving a first window handle for a first moving image reproducing program;
comparing the first window handle with a second window handle for a second moving image reproducing program that is to be highlighted;
outputting coordinates of the second window handle when the first and second window handles are the same; and
outputting control values for controlling red (R), green (G), blue (B) video signals, a contrast, or a sharpness of a highlight region of the screen that is formed with coordinates of the second window handle.

2. The method of claim 1, wherein the comparing of the first and second window handles comprises:
comparing a first class name of the first window handle with a second class name of the second window handle.

3. A computer-readable recording medium encoded with data readable by a computer to implement a method of transmitting a control signal to highlight a highlighting region on a screen of a display device, the computer-readable recording medium comprising:
data used to receive a first window handle for a first moving image reproducing program;
data used to compare the first window handle with a second window handle for a second moving image reproducing program that is to be highlighted;
data used to output coordinates corresponding to the second window handle when the first and second window handles are the same: and
data used to output control values for adjusting R,G,B video signals, a contrast, or a sharpness of a region that is formed with the coordinates corresponding to the second window handle.

4. The computer-readable recording medium of claim 3, wherein the data used to compare the first window handle with the second window handle comprises:
data used to compare a first class name for the first window handle with a second class name of the second window handle.

5. A method of highlighting a screen of a display device, in which a moving image is to be reproduced, the method comprising:
receiving coordinates of the moving image corresponding to a highlighting region of the screen in a highlight mode;
receiving control values for each controlling R, G, B video signal, a contrast or a sharpness of the highlighting region; and
controlling the R, G, B video signals, the contrast or the sharpness of the highlighting region according to the control values and the coordinates.

6. A method of highlighting a screen of a display device, the method comprising:
receiving moving image window coordinates corresponding to a highlighting region of the screen in which a moving image is to be reproduced; and
receiving control values to increase a luminance of the highlighting region and automatically increasing the luminance of the highlighting region to be brighter than the luminance of other regions of the screen.

7. A display device for highlighting a screen, comprising:
a control circuit receiving moving image coordinates to set a highlighting region of the screen, in which a moving image is reproduced, in a highlight mode, and control values that are used to control R, G, B video signals, a contrast, or a sharpness, and outputting signals representing the set highlighting region and the control values; and
a cathode display tube displaying an image according to the R,G,B video signals adjusted in response to the signals output from the control circuit.

8. A display device for highlighting a screen, comprising:
a control unit receiving information corresponding to moving image window coordinates and control values controlling a characteristic of the screen, calculating coordinates from the received information to set a highlighting region, in which a moving image is displayed, of the screen according to a resolution of the screen in a highlight mode, and processing the received information to highlight the set highlighting region of the screen.

9. The display device of claim 8, wherein the control unit adjusts R, G, B video signals and at least one of a contrast, a sharpness, and a luminance of the set highlighting region of the screen according to the received information.

10. The display device of claim 9, wherein the control unit increases the luminance of the set highlighting region of the screen according to the received information.

11. The display device of claim 9, wherein the control unit increases the luminance of the set highlighting region of the screen brighter than that of another region of the screen according to the received information.

12. The display device of claim 9, wherein the control unit outputs signals representing the set highlighting region and the adjusted R, G, B video signals.

13. The display device of claim 12, further comprising:
a display unit displaying an image according to the adjusted R, G, B video signals in response to the signals output from the control circuit.

14. The display device of claim 8, wherein the control unit adjusts the moving image according to the set highlighting region.

15. A computer system for highlighting a screen, comprising:
a computer generating information corresponding to moving image window coordinates of a highlighting region of the screen and control values corresponding to a characteristic of the highlighting region in which a moving image is displayed; and
a display device receiving the information, calculating coordinates from the received information to set the highlighting region of the screen of the display device according to a resolution of the screen of the display device in a highlight mode, and processing the received information to highlight the set highlighting region of the screen.

16. The computer system of claim 15, wherein the computer comprises one of a first USB port, a first serial port, and a parallel port, through which the information is transmitted to the display device, and the display device comprises one of a second USB port, a second serial port, and a second parallel port coupled to the one of the first USB port, the first serial port, and the parallel port to receive the information.

17. The computer system of claim 15, wherein the display device comprises:
one of a color display tube, a liquid crystal display device, and a plasma display panel.

18. The computer system of claim 15, wherein the screen of the display device comprises a non-highlighting region other than the highlighting region, and the display device does not highlight the non-highlight region.

19. The computer system of claim 19, wherein the display device generates a first video signal forming the moving image of the highlighting region highlighted in one of a contrast, a sharpness, and a luminance, and a second video signal forming the non-highlighting region on the screen.

20. The computer system of claim 15, wherein the display device comprises:
a control unit generating an OSD image representing a size of the highlighting region on the screen to adjust the size of the highlighting region.

21. The computer system of claim 20, wherein the OSD image generated on the screen of the display device comprises:
a shape representing the size of the highlighting region.

22. The computer system of claim 15, wherein the display device comprises:
a control unit generating an OSD image representing a location of the highlighting region on the screen to adjust the location of the highlighting region.

23. The computer system of claim 22, wherein the OSD image generated on the screen of the display device comprises:
top-left coordinates and bottom-right coordinates.

24. The computer system of claim 15, wherein the display device adjusts R, G, B video signals and at least one of a contrast, a sharpness, and a luminance of the set highlighting region of the screen according to the received information.

25. The computer system of claim 24, wherein the display device comprises:
a control unit generating on the screen a control window representing levels of the R, G, B signals and the at least one of the contrast, the sharpness, and the luminance of the set highlighting region of the screen to adjust the levels through the control window.

26. The computer system of claim 24, wherein the computer generates a signal representing an adjusting dialog, and the display device generates a menu in response to the adjusting dialog to display the menu corresponding to at least one level of the R, G, B video signals, the contrast, the sharpness, and the luminance of the set highlighting region on the screen.

27. The computer system of claim 26, wherein the display device adjusts the one level of the R, G, B video signals, the contrast, the sharpness, and the luminance which are displayed on the screen.

28. The computer system of claim 15, wherein the computer comprises:
a highlighting program unit comparing a first window handle corresponding to a first moving image reproducing program with a second window handle for a second moving image reproducing program that is to be highlighted, and outputting the information corresponding to the moving image window coordinates and the control values when the first and second window handles are the same.

29. The computer system of claim 28, wherein the computer comprises a third moving image reproducing program having a third window handle, compares the third window handle corresponding to the first moving image reproducing program with the second window handle for the second moving image reproducing program that is to be highlighted, when the first and second window handles are not the same, and outputs the information upon comparing the third window handle with the second window handle.

30. The computer system of claim 29, wherein the second and third moving image reproducing programs are the same, and the second and third window handles are not the same.

31. The computer system of claim 28, wherein the computer calculates the moving image window coordinates of the highlighting region from one of the first and second window handles.

32. The computer system of claim 31, wherein the highlighting region has a second resolution which is different from the resolution of the set highlighting region of the screen of the display device.

33. The computer system of claim 31, wherein the highlighting region has a second resolution which is the same as the resolution of the set highlighting region of the screen of the display device.

34. The computer system of claim 15, wherein the computer comprises:
a moving image reproducing program unit generating the moving image;
a hooking program unit generating a window handle representing the moving image window coordinates;
a memory storing the control values; and
a highlighting program unit generating the information, which is transmitted to the display device together the moving image, in response to the control values and the window handle.

35. The computer system of claim 34, wherein the computer comprises a plurality of window handles representing a plurality of moving image window coordinates, and the hooking program unit selects one of the window handles to generate the window handle.

36. The computer system of claim 34, wherein the highlighting program unit of the computer generates a signal to modify the control values and stores the modified control values in the memory.

37. The computer system of claim 36, wherein the highlighting program unit generates the information having the modified control values as the control values.

38. The computer system of claim 36, wherein the highlighting program unit generates an image representing the control value and the modified control values.

39. The computer system of claim 34, wherein the computer comprises one of a keyboard and a mouse, and the highlighting program unit generates an adjusting dialog to display a menu on the screen to adjust the control values using the one of the keyboard and the mouse.

40. A computer system for highlighting a screen of a display device, comprising:
a moving image reproducing program unit generating a moving image;
a hooking program unit generating a window handle representing moving image window coordinates corresponding to a highlighting region of the screen in which the moving image is reproduced and displayed;
a memory storing control values controlling a characteristic of the highlighting region; and
a highlighting program unit outputting information, which is transmitted to the display device together the moving image, representing the control values and the moving image window coordinates.

41. The computer system of claim 40, wherein computer comprises a plurality of window handles representing a plurality of moving image window coordinates, and the hooking program unit selects one of the window handles to generate the window handle.

42. The computer system of claim 40, wherein the highlighting program of the computer generates a signal to modify the control values and stores the modified control values in the memory.

43. The computer system of claim 40, wherein the highlighting program generates the information having the modified control values as the control values.

44. The computer system of claim 40, wherein the computer comprises one of a keyboard and a mouse, and the highlighting program generates an adjusting dialog to display a menu on the screen to adjust the control values using the one of the keyboard and the mouse.

45. The computer system of claim 40, wherein the highlighting program adjusts one of a size and a location of the highlighting region in the screen and generates the adjusted moving image window coordinates as the moving image window coordinates.

46. The computer system of claim 40, wherein the characteristic of the highlighting region comprises:
at least one of R, G, B video signals, a contrast, a sharpness, and a luminance of the highlighting region.

47. The computer system of claim 46, wherein the highlighting program adjusts the one of the R, G, B video signals, a contrast, a sharpness, and a luminance of the highlighting region.

48. A method in a computer system for highlighting a screen of a display device, the method comprises:
generating information corresponding to moving image window coordinates of a highlighting region of the screen and control values corresponding to a characteristic of the highlighting region in which a moving image is displayed;
calculating coordinates from the information to set the highlighting region of the screen of the display device according to a resolution of the screen of the display device in a highlight mode; and
highlighting the set highlighting region of the screen according to the calculated coordinates and the control values.

49. The method of claim 48, wherein the screen of the display device comprises a non-highlighting region other than the highlighting region, and the highlighting of the set highlighting region of the screen comprises:
preventing the non-highlight region from being highlighted on the screen.

50. The method of claim 48, wherein the highlighting of the set highlighting region of the screen comprises:
generating a first video signal forming the moving image of the set highlighting region highlighted in one of a contrast, a sharpness, and a luminance, and a second video signal forming the non-highlighting region on the screen.

51. The method of claim 50, wherein the characteristic of the highlighting region in which the moving image is displayed, comprises at least one of R, G, B video signals, a contrast, a sharpness, and a luminance of the highlighting region, and the highlighting of the set highlighting region of the screen comprises:
adjusting one of the R, G, B video signals, the contrast, the sharpness, and the luminance of the highlighting region.

52. The method of claim 48, wherein the highlighting of the set highlighting region of the screen comprises:
adjusting one of a size and a location of the highlighting region in the screen.

53. The method of claim 48, wherein the highlighting of the set highlighting region of the screen comprises:
adjusting a shape representing the highlighting region.

54. The method of claim 48, wherein the generating of the information comprises:
comparing a first window handle corresponding to a first moving image reproducing program with a second window handle for a second moving image reproducing program that is to be highlighted; and
outputting the information corresponding to the moving image window coordinates and the control values when the first and second window handles are the same.

55. The method of claim 54, wherein the generating of the information comprises:
comparing a third moving image reproducing program having a third window handle with the second window handle for the second moving image reproducing program that is to be highlighted, when the first and second window handles are not the same; and
outputting the information upon comparing the third window handle with the second window handle.

56. The method of claim 48, wherein the generating of the information comprises:
selecting one of a plurality of window handles representing a plurality of moving image window coordinates.

57. A method in a computer system for highlighting a screen of a display device, the method comprising:
generating a moving image;
generating a window handle representing moving image window coordinates corresponding to a highlighting region of the screen in which the moving image is reproduced and displayed;
generating control values controlling a characteristic of the highlighting region; and
outputting information, which is transmitted to the display device together the moving image, representing the control values and the moving image window coordinates.

58. The method of claim 57, wherein the generating of the window handle comprises:
modifying the control values and storing the modified control values in a memory; and
outputting the modified control values as the control values.

59. The method of claim 57, wherein the generating of the window handle comprises:
modifying one of a size and a location of the highlighting region in the screen; and
generating the adjusted moving image window coordinates as the moving image window coordinates.

60. The method of claim 57, wherein the characteristic of the highlighting region comprises at least one of R, G, B video signals, a contrast, a sharpness, and a luminance of the highlighting region, and the generating of the control values comprises:
adjusting the one of the R, G, B video signals, a contrast, a sharpness, and a luminance of the highlighting region; and
generating the adjusted one as the control values.
